(19) United States
(12) Patent Application Publication
(10) Pub. No.: US 2024/0198364 A1
(43) Pub. Date: Jun. 20, 2024

(54) BACK NOZZLE, SUBSTRATE TREATING APPARATUS AND METHOD FOR MANUFACTURING BACK NOZZLE

(71) Applicant: SEMES CO., LTD., Chungcheongnam-do (KR)

(72) Inventors: Sang Hu HAN, Chungcheongnam-do (KR); Oh Jin KWON, Chungcheongnam-do (KR); Yong PARK, Chungcheongnam-do (KR)

(21) Appl. No.: 18/479,884

(22) Filed: Oct. 3, 2023

(30) Foreign Application Priority Data
Dec. 20, 2022 (KR) 10-2022-0178877
Apr. 26, 2023 (KR) 10-2023-0054534

(51) Int. Cl. B05B 1/14; B05B 13/02; B29C 45/00; B29C 45/17

(52) U.S. Cl. CPC B05B 1/14; B05B 13/0278; B29C 45/0055; B29C 45/17; B29L 2023/22

(57) ABSTRACT

The present disclosure provides a back nozzle, a substrate treating apparatus, and a method for manufacturing a back nozzle. The back nozzle according to an embodiment of the present disclosure includes a base module formed with a central nozzle pipe; and a plurality of side modules installed along the side portion of the base module, some of which have peripheral nozzle pipes formed thereon.

### CROSS-REFERENCE TO RELATED APPLICATION (S)

This application claims benefit of priority to Korean Patent Application No. 10-2022-0178877 filed on Dec. 20, 2022 and No. 10-2023-0054534 filed on Apr. 26, 2023 in the Korean Intellectual Property Office, the disclosures of which are incorporated herein by reference in their entirety.

### BACKGROUND

### 1. Field

The present disclosure relates to a back nozzle for spraying a chemical liquid or gas onto a bottom side of a substrate, a substrate treating apparatus, and a method for manufacturing a back nozzle.

### 2. Description of Related Art

In general, semiconductor devices are manufactured by depositing various materials on a substrate in the form of a thin film and patterning these materials. To this end, several different processes are required in various stages, such as a deposition process, a photolithography process, an etching process, a cleaning process, and a drying process.

Among these, the cleaning process and the drying process are processes that remove foreign objects or particles present on the substrate and then dry the foreign objects or particles, and are performed by supplying a processing liquid to an upper surface or a lower surface of the substrate while the substrate rotates at high speed in a state of being supported on a spin head (chuck base).

Meanwhile, in order to supply the processing liquid to the lower surface of the substrate, a back nozzle unit is installed on the support unit of the substrate. This back nozzle unit includes a supply unit with a built-in chemical liquid supply line or gas supply line, and a back nozzle that sprays a chemical liquid or gas onto the substrate. In this case, the back nozzle is composed of a housing and a nozzle pipe, and the nozzle pipe connected to the chemical liquid supply line or the gas supply line is inserted into the housing and assembled.

However, the nozzle pipe of the back nozzle moves upward when the high-temperature chemical liquid is discharged, that is, the nozzle pipe protrudes, which causes a limitation in that the chemical liquid or gas is not properly sprayed onto the bottom side of the substrate.

### RELATED ART DOCUMENT

### Patent Document

(Patent Document 1) Korea Patent Laid-open Publication No. 10-2011-0080935

### SUMMARY

An aspect of the present disclosure is to provide a back nozzle, a substrate treating apparatus, and a method for manufacturing a back nozzle, capable of preventing a nozzle pipe of the back nozzle from protruding upwardly.

According to an aspect of the present disclosure, a back nozzle includes: a base module formed with a central nozzle pipe; and a plurality of side modules installed along a side portion of the base module, some of which have peripheral nozzle pipes formed thereon.

The central nozzle pipe may be integrally formed with the base module, and the peripheral nozzle pipe may be integrally formed with the side module.

The base module may have a plurality of pipe holes formed around the central nozzle pipe, and the peripheral nozzle pipe may be inserted into the pipe holes and assembled.

The remainder of the plurality of side modules may be formed with assembly pillars, and the assembly pillars may be inserted into the pipe holes and assembled.

The base module may have a plurality of base holes formed along the side portion thereof, the side module may be formed with a side hole corresponding to the base hole, and the side module may be fixed to the base module by fastening a bolt member to the side hole and the base hole.

According to another aspect of the present disclosure, a substrate treating apparatus includes: a plurality of process chambers respectively performing a process on a substrate; a support unit disposed within the process chamber and supporting the substrate; and a back nozzle unit disposed to penetrate through the support unit, in which the back nozzle unit may include a supply unit with a built-in chemical liquid supply line or gas supply line; and a back nozzle connected to the chemical liquid supply line or the gas supply line, installed at an upper end of the supply unit, and spraying a chemical liquid or gas toward a bottom side of the substrate, and the back nozzle may include a base module formed with a central nozzle pipe; and a plurality of side modules installed along the side portion of the base module, some of which have peripheral nozzle pipes formed thereon.

According to another aspect of the present disclosure, a method for manufacturing a back nozzle includes: a module injection operation of forming a plurality of modules by injecting a resin liquid to form parts of a back nozzle having a nozzle pipe; and a module assembly operation of assembling the plurality of modules to make the back nozzle, in which the nozzle pipe formed in at least one of the plurality of modules may be integrally formed with the module.

The plurality of modules may include one base module and a plurality of side modules, the nozzle pipe may include a peripheral nozzle pipe formed on the side module, and the module injection operation may include: a base injection operation of manufacturing the base module in which a plurality of pipe holes are formed; and a side portion injection operation of manufacturing the plurality of side modules, and in the side portion injection operation, some of the plurality of side modules may be formed with the peripheral nozzle pipe corresponding to the pipe holes.

The nozzle pipe may further include a central nozzle pipe formed in the base module, and in the base injection operation, a central portion of the base module may be formed with the central nozzle pipe.

In the base injection operation, a plurality of base holes may be formed along the side portion of the base module, and in the side portion injection operation, the side module may be formed with a side hole corresponding to the base hole.

The module assembly operation may include: a module arrangement operation of arranging the plurality of side modules in the base module so that the base hole and the side hole communicate with each other; and a module fixing operation of fixing the side module to the base module by fastening a bolt member to the side hole and the base hole.

The module assembly operation may further include a peripheral nozzle pipe insertion operation of inserting the peripheral nozzle pipes of some of the plurality of side modules into the pipe holes of the base module, before the module arrangement operation.

In the side portion injection operation, the remainder of the plurality of side modules may be formed with assembly pillars corresponding to the pipe holes.

The module assembly operation may further include an assembly pillar insertion operation of inserting the assembly pillars of the remainder of the plurality of side modules into the pipe holes of the base module, before the module arrangement operation.

In the side portion injection operation, the peripheral nozzle pipe may be formed in a structure where an upper end portion is closed, and the method for manufacturing a back nozzle may further include a pipe end cutting operation of cutting the closed upper end portion of the peripheral nozzle pipe to form a pipe outlet, after the module assembly operation.

In the pipe end cutting operation, the closed upper end portion of the peripheral nozzle pipe may be cut horizontally or obliquely to select a direction of the pipe outlet.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a diagram illustrating a housing of a back nozzle according to the related art.

FIG. 2 is a cross-sectional view taken along line I-I′ of FIG. 1, and illustrates that a nozzle pipe is inserted into the housing and assembled.

FIG. 3 is a diagram illustrating a back nozzle with the nozzle pipe assembled in the housing of FIG. 2.

FIG. 4 is a diagram illustrating that the nozzle pipe rises from the housing in the back nozzle of FIG. 3.

FIG. 5 is a plan view illustrating a process chamber of a substrate treating apparatus according to an embodiment in the present disclosure.

FIG. 6 is a diagram illustrating an inside of the process chamber of FIG. 5.

FIG. 7 is a perspective view illustrating a back nozzle according to an embodiment in the present disclosure.

FIG. 8 is a plan view illustrating the back nozzle of FIG. 7.

FIG. 9 is a perspective view illustrating a base module of the back nozzle of FIG. 7.

FIG. 10 is a perspective view illustrating that one side module is assembled to the base module of FIG. 9.

FIG. 11 is a perspective view illustrating that another side module is assembled to the base module of FIG. 10.

FIG. 12 is a perspective view illustrating that another side module is assembled to the base module of FIG. 11.

FIG. 13 is a perspective view illustrating that the remaining side modules are assembled to the base module of FIG. 12.

FIG. 14 is a flow chart illustrating a method for manufacturing a back nozzle according to an embodiment in the present disclosure.

### DETAILED DESCRIPTION

Hereinafter, embodiments will be described in detail with reference to the accompanying drawings so that they can be easily practiced by those skilled in the art to which the present disclosure pertains. However, in describing exemplary embodiments in the present disclosure, detailed descriptions of well-known functions or constructions will be omitted so as not to obscure the description of the present disclosure with unnecessary detail. In addition, like or similar reference numerals denote parts performing similar functions and actions throughout the drawings. In addition, in this specification, terms such as ‘upper,’ ‘upper portion,’ ‘upper surface,’ ‘lower,’ ‘lower portion,’ “lower surface,’ ‘side surface,’ etc., are based on the drawings, and in reality, may vary depending on a direction in which the components are arranged.

A case in which any one part is connected with the other part includes a case in which the parts are directly connected with each other and a case in which the parts are indirectly connected with each other with other elements interposed therebetween. In addition, a phrase ‘including any component’ will be understood to imply the inclusion of other components rather than the exclusion of other component, unless explicitly described otherwise.

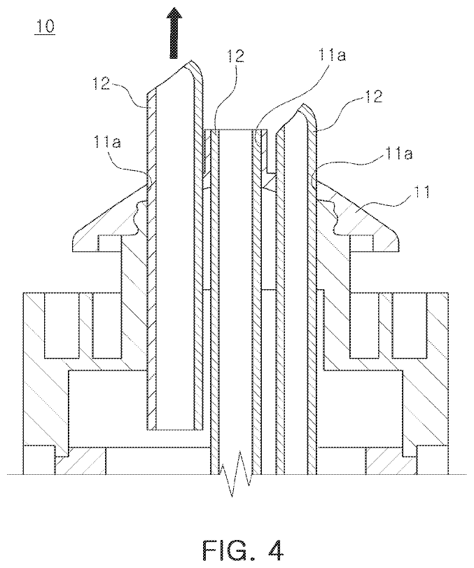

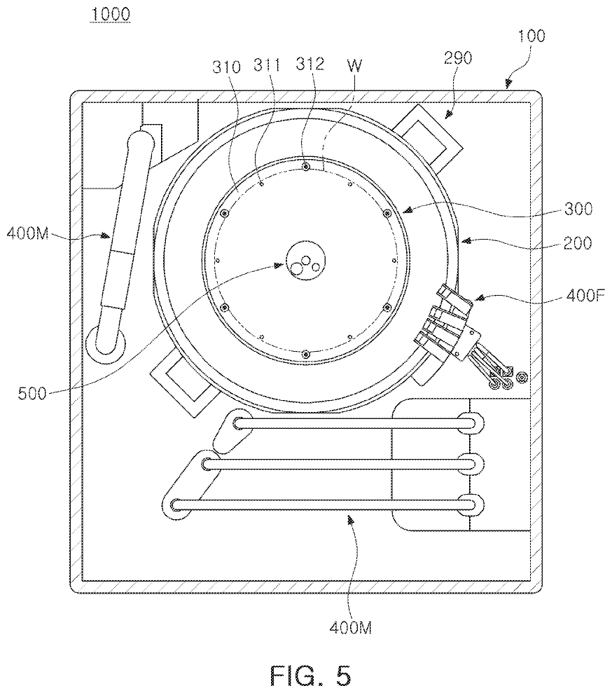

FIG. 4 is a plan view illustrating a process chamber of a substrate treating apparatus according to an embodiment in the present disclosure, and FIG. 5 is a diagram illustrating the inside of the process chamber of FIG. 4.

Referring to the drawings, a substrate treating apparatus 1000 of the present disclosure includes a process chamber 100 for performing a process on a substrate W using a liquid. Within this process chamber 100, a process is performed on a substrate W while the substrate W is maintained horizontally. The process may be a process of etching a nitride film formed on the substrate W. In this case, the liquid may contain phosphoric acid. Furthermore, the process chamber 100 may be used in a process of removing foreign objects and film materials remaining on a surface of the substrate W using various liquids.

Specifically, the process chamber 100 provides a sealed internal space, and a fan filter unit 110 is installed at the top. The fan filter unit 110 generates a vertical airflow inside the process chamber 100. This fan filter unit 110 is a module in which a filter and an air supply fan are integrated into one unit, and filters clean air and supplies the filtered air into the process chamber 100. After passing through the fan filter unit 110, the clean air is supplied to the process chamber 100 to form a vertical airflow. This vertical airflow provides a uniform airflow to an upper portion of the substrate W, and pollutants (fumes) generated in the process of treating the surface of the substrate W by the treatment fluid are discharged to discharge lines 131, 132, and 133 together with air through bowls 210, 220, and 230 of a treatment vessel 200 to maintain a high level of cleanliness inside the treatment vessel.

The process chamber 100 includes a process area 100a and a maintenance area 100b partitioned by a horizontal partition wall 101. A driving member 293 of a lifting unit 290 and a driving member 490 of a nozzle unit 400 are installed on a horizontal partition wall 101. In addition, the maintenance area 100b is a space where the discharge lines 131, 132, 133 and the exhaust line 120 connected to the processing vessel 200 are located. It is preferable that the maintenance area 100b is isolated from the process area 100a where the substrate W is processed.

The substrate treating apparatus 1000 of the present disclosure may include a processing vessel 200, a support unit 300, and a nozzle unit 400 within the process chamber 100. The processing vessel 200 is installed inside the process chamber 100, has a cylindrical shape with an upper portion open, and provides a processing space for processing the substrate W. The open upper surface of the processing vessel 200 is provided as a loading and unloading passage of the substrate W. Here, a support unit 300 is located in the processing space. In this case, the support unit 300 supports the substrate W and rotates the substrate W during the process.

In addition, the processing vessel 200 has an upper space 200a where a spin head 310 of the support unit 300 is located, and a lower space 200b where an exhaust collection unit 250 is connected to a lower portion to enable forced exhaust. The exhaust collection unit 250 is connected to the exhaust line 120 extending to the outside of the process chamber 100. Annular first, second, and third bowls 210, 220, and 230, which introduce and suck a chemical liquid and gas scattered on the rotating substrate W, are arranged in multi stage. The first, second, and third bowls 210, 220, and 230 have exhaust ports h communicating with one common annular space (corresponding to a lower space of the processing vessel).

Here, the first, second, and third bowls 210, 220, and 230 provide first to third recovery spaces RS1, RS2, and RS3 into which an airflow containing a liquid and fume scattered from the substrate W is introduced. The first recovery space RS1 is formed by being partitioned by the first bowl 210, the second recovery space RS2 is formed as a separation space between the first bowl 210 and the second bowl 220, and the third recovery space RS3 is formed as a separation space between the second bowl 220 and the third bowl 230.

In addition, the processing vessel 200 is coupled with a lifting unit 290 that changes a vertical position of the processing vessel 200. The lifting unit 290 linearly moves the processing vessel 200 up and down. As the processing vessel 200 moves up and down, a relative height of the processing vessel 200 with respect to the spin head 310 changes. The lifting unit 290 has a bracket 291, a moving shaft 292, and a driving member 293. The bracket 291 is fixedly installed on an outer wall of the processing vessel 200, and the moving shaft 292, which moves in the vertical direction by the driving member 293, is fixedly coupled to the bracket 291. When the substrate W is loaded into or unloaded from the spin head 310, the processing vessel 200 is lowered so that the spin head 310 protrudes toward the upper portion of the processing vessel 200.

In addition, as the process progresses, the height of the processing vessel 200 is adjusted so that the liquid may be introduced into the preset bowls 210, 220, and 230 depending on the type of liquid supplied to the substrate W. Accordingly, the relative vertical position between the processing vessel 200 and the substrate W changes. Accordingly, the processing vessel 200 may vary the types of liquid and polluted gas recovered for each recovery space RS1, RS2, and RS3.

The support unit 300 is installed inside the processing vessel 200. The support unit 300 may support the substrate W while the process is in progress, and rotate by the driving member 330 while the process is in progress. In addition, the support unit 300 has a spin head 310 having a circular upper surface. The upper surface of the spin head 310 has a plurality of support pins 311 and a plurality of chucking pins 312 that support the substrate W. A plurality of support pins 311 are arranged in a certain arrangement at regular intervals on an edge portion of the upper surface of the spin head 310, and are provided to protrude upward from the spin head 310. The support pin 311 supports a lower surface of the substrate W so that the substrate W is supported while being spaced upward from the spin head 310. A plurality of chucking pins 312 are arranged on the outside of the support pin 311, and these chucking pins 312 are provided to protrude upward. The plurality of chucking pins 312 aligns the substrate W supported by the plurality of support pins 311 so that the substrate W is disposed in a correct position on the spin head 310. During the process, the plurality of chucking pins 312 is in contact with the side portion of the substrate W to prevent the substrate W from deviating from the correct position. A support shaft 320 supporting the spin head 310 is connected to the lower portion of the spin head 310, and the support shaft 320 rotates by the driving member 330 connected to the lower end. In this case, the driving member 330 is provided with a motor, etc., and as the support shaft 320 rotates by the driving member 330, the spin head 310 and the substrate W rotate.

Then, the nozzle unit 400 discharges a liquid to the substrate W supported on the support unit 300. The nozzle unit 400 may be a moving nozzle device 400M or a fixed nozzle device 400F. In this case, a plurality of moving nozzle devices 400M may be installed outside the processing vessel 200.

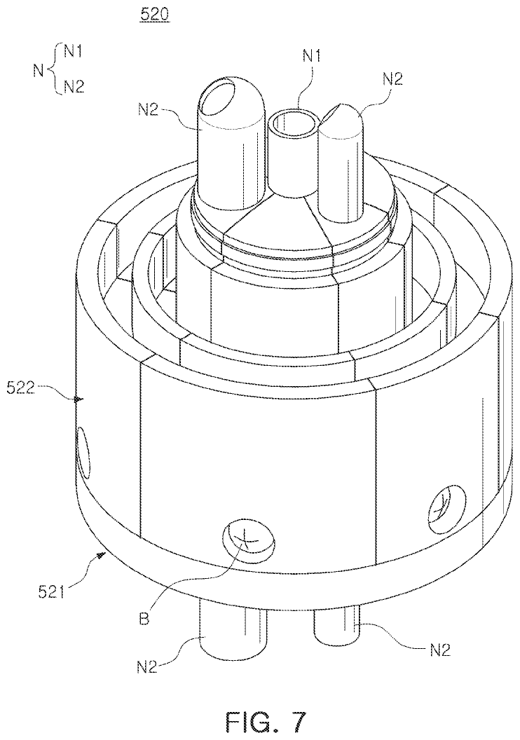

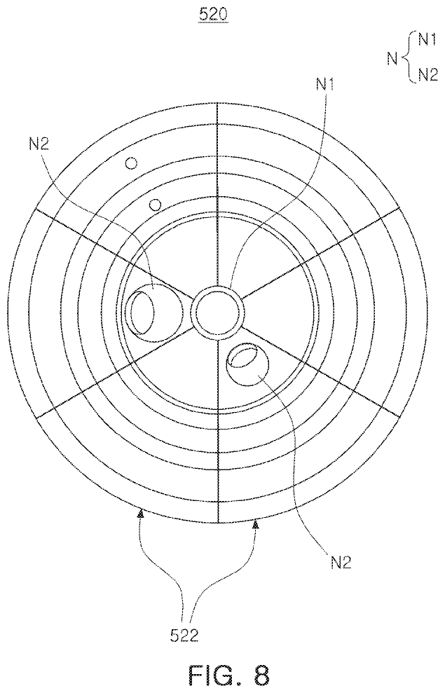

FIG. 7 is a perspective view illustrating a back nozzle according to an embodiment in the present disclosure, and FIG. 8 is a plan view illustrating the back nozzle of FIG. 7.

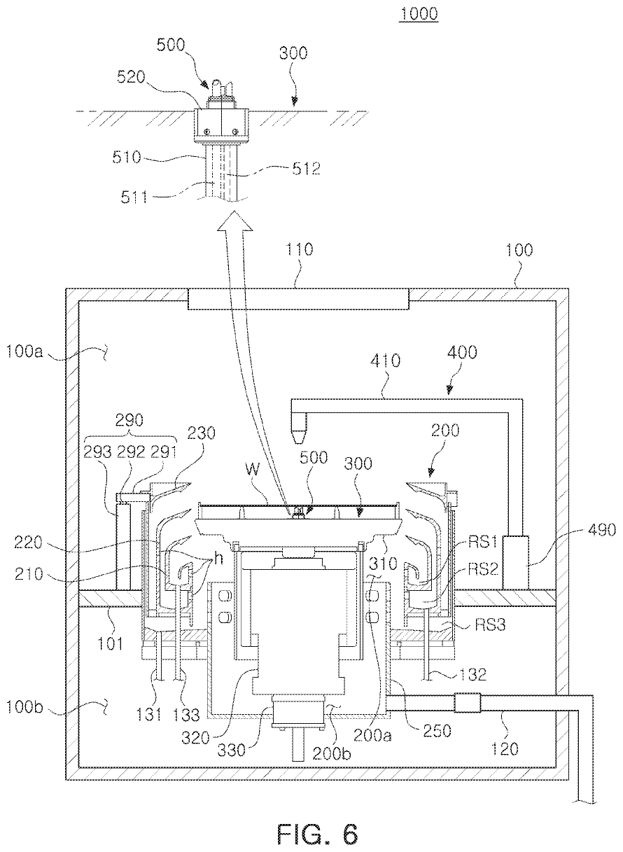

Referring to FIGS. 6 through 8, the substrate treating apparatus 1000 according to an embodiment in the present disclosure includes a back nozzle unit 500 disposed inside the process chamber 100 described above. The process chamber 100 performs a process on a substrate inside and may have an internal structure as illustrated in FIG. 6. A back nozzle unit 500 penetrating through the support unit 300 supporting the substrate W is disposed within the process chamber 100.

The back nozzle unit 500 includes a supply unit 510 and a back nozzle 520. In this case, the supply unit 510 has a built-in chemical liquid supply line 511 or gas supply line 512. In addition, the back nozzle 520 is installed at an upper end of the supply unit 510 while being connected to the chemical liquid supply line 511 or the gas supply line 512.

However, in the back nozzle of the related art, the nozzle pipe that is separately configured from the housing is inserted into the housing and assembled, whereas the back nozzle 520 of the present disclosure is configured to be integrated with a nozzle pipe N, thereby preventing the nozzle pipe N from rising during the discharge of the high-temperature chemical liquid.

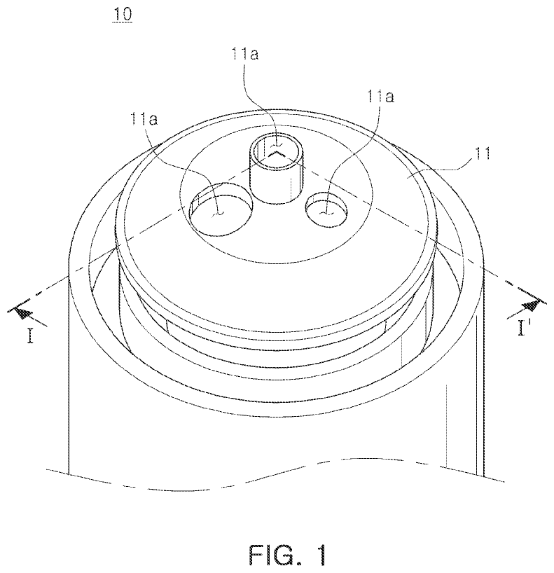

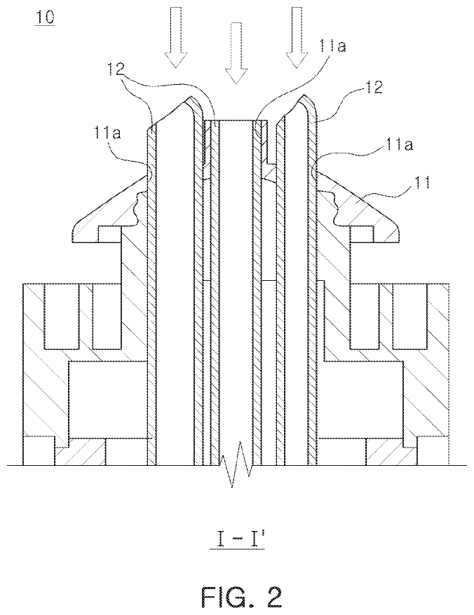

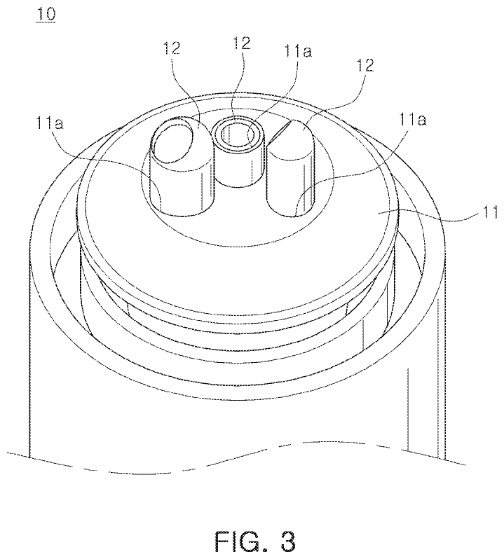

As illustrated in FIGS. 1 through 3, the back nozzle 10 according to the related art has a structure in which the nozzle pipe 12 manufactured separately from the housing 11 is inserted into and assembled to the housing 11. In this way, the nozzle pipe 12 is a separate component from the housing 11, and when the nozzle pipe 12 is assembled to the housing 11 by being simply inserted into an assembly hole 11a of the housing 11, the nozzle pipe 12 may be easily removed from the housing 11.

Specifically, in the back nozzle 10 according to the related art, the nozzle pipe 12 is assembled by being press-fitted into the assembly hole 11a of the housing 11. However, when the high-temperature chemical liquid is discharged through the nozzle pipe 12, the high temperature of the chemical liquid may affect the nozzle pipe 12, causing a certain degree of deformation. As a result, the nozzle pipe 12 is in a state where it may be easily removed from the assembly hole 11a of the housing 11. In this case, as illustrated in FIG. 4, the nozzle pipe 12 rises from the assembly hole of the housing 11 by the discharge pressure of the chemical liquid discharged upward, and as a result, as the upper side of the nozzle pipe 12 protrudes, the chemical liquid or gas is not properly sprayed onto the bottom side of the substrate.

On the other hand, the back nozzle 520 according to an embodiment in the present disclosure illustrated in FIGS. 7 and 8 is configured to be integrated with the nozzle pipe N to prevent the nozzle pipe N from rising when the high-temperature chemical liquid is discharged.

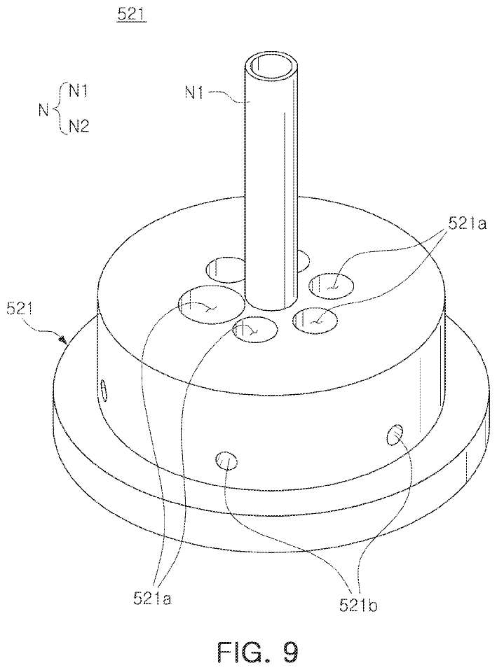

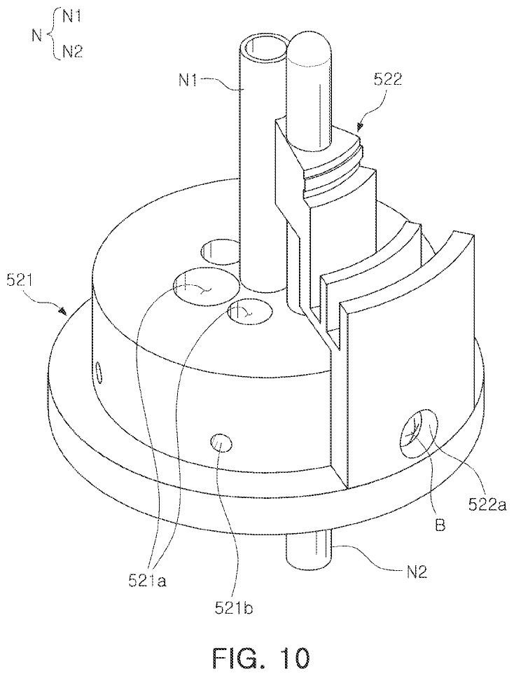

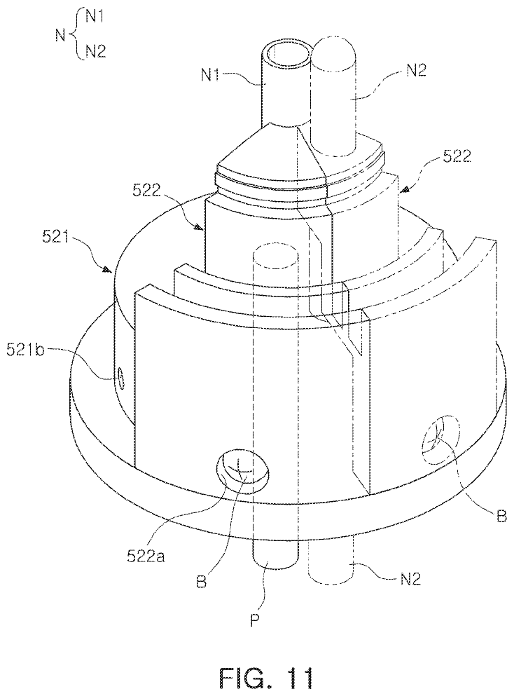

FIG. 9 is a perspective view illustrating the base module of the back nozzle of FIG. 7, FIG. 10 is a perspective view illustrating that one side module is assembled to the base module of FIG. 9, and FIG. 11 is a perspective view illustrating that another side base module of FIG. 10 is assembled to the base module of FIG. 10.

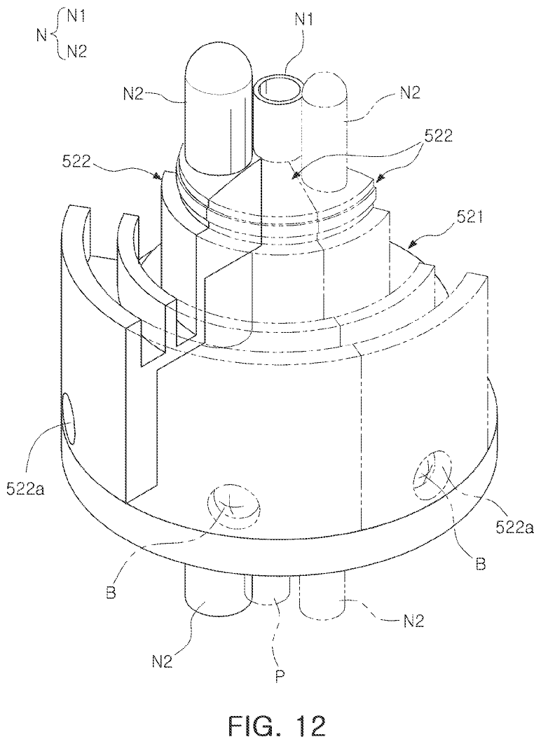

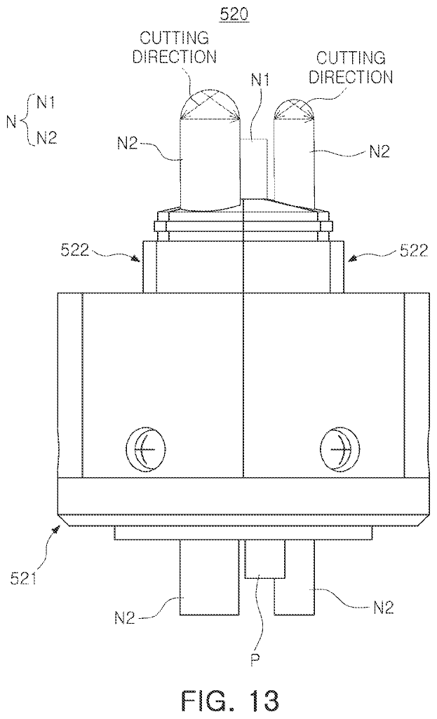

In addition, FIG. 12 is a perspective view illustrating that another side module is assembled to the base module of FIG. 11, and FIG. 13 is a perspective view illustrating that the remaining side modules are assembled to the base module of FIG. 12.

Referring to the drawings, the back nozzle 520 of the present disclosure includes a base module 521 and a side module 522.

The base module 521 is disposed in the central portion of the back nozzle 520, and a plurality of side modules 522 are installed along the side portion of the base module 521. The nozzle pipe N of the back nozzle 520 includes a central nozzle pipe N1 formed in the central portion of the back nozzle 520 and a peripheral nozzle pipe N2 arranged around the central nozzle pipe N1.

Here, the central nozzle pipe N1 is formed in the base module 521, and the peripheral nozzle pipe N2 is formed in at least one of the plurality of side modules 522. In this case, the central nozzle pipe N1 is integrally formed with the base module 521, and the peripheral nozzle pipe N2 is integrally formed with the side modules 522.

In other words, the back nozzle 520 may be divided into a base module 521 and a side module 522. The base module 521 has a central nozzle pipe N1, which is one type of nozzle pipe (N), formed as an integrated structure, that is, as one part. In addition, the side module 522 has a peripheral nozzle pipe N2, which is another type of nozzle pipe N), formed as an integrated structure, that is, as one part. In this case, the remaining part of the base module 521 excluding the central nozzle pipe N1 serves as a part of the housing of the back nozzle 520, and the remaining part of the plurality of side modules 522 excluding the peripheral nozzle pipe N2 serves as the remaining part of the housing of the back nozzle 520.

Specifically, the base module 521 has a pipe hole 521a formed around the central nozzle pipe N1, and the peripheral nozzle pipe N2 may be inserted into and assembled to the pipe hole 521a.

The base module 521 is shaped like a circular block with a constant thickness in a longitudinal direction, and the plurality of pipe holes 521a are formed around the central nozzle pipe N1 and each of the plurality of pipe holes 521a is formed longitudinal direction like the central nozzle pipe N1.

In this case, when a part of the plurality of side modules 522 is assembled to the base module 521, the back nozzle 520 has a structure in which the peripheral nozzle pipe N2 is inserted into the pipe hole 521a of the base module 521 and arranged to penetrate through the pipe hole 521a. Therefore, some of the plurality of side modules 522 are arranged to extend in the longitudinal direction without the peripheral nozzle pipe N2 interfering with the base module 521, and may be connected to the chemical liquid supply line 511 or the gas supply line 512 formed in the lower supply unit 510. In addition, as the peripheral nozzle pipe N2 is inserted into and arranged in the pipe hole 521a, some of the plurality of side modules 522 may be firmly assembled to the base module 521.

Furthermore, an assembly pillar P may be formed in the remainder of the plurality of side modules 522. The assembly pillar P may be inserted into and assembled to the pipe hole 521a of the base module 521. That is, when the remainder of the plurality of the plurality of side modules 522 is assembled to the base module 521, the back nozzle 520 has a structure in which the assembly pillar P is inserted into the pipe hole 521a of the base module 521 and arranged to penetrate through the pipe hole 521a. Therefore, as the assembly pillar P is inserted into and arranged in the pipe hole 521a, the remainder of the plurality of side modules 522 may be firmly assembled to the base module 521.

The assembly of the side module 522 to the base module 521 may be firmly fixed by fastening of a bolt member B. The base module 521 may have a plurality of base holes 521b formed along the side portion of the base module 521, and the side module 522 may be formed with a side hole 522a corresponding to the base hole 521b. In this case, the side module 522 is fixed to the base module 521 by fastening the bolt member B to the side hole 522a and the base hole 521b. For reference, the assembly pillar P may not be formed in the remainder of the plurality of side modules 522, Even if the assembly pillar P is not formed, the side module 522 may be assembled and fixed to the base module 521 by the fastening of the bolt member B as described above.

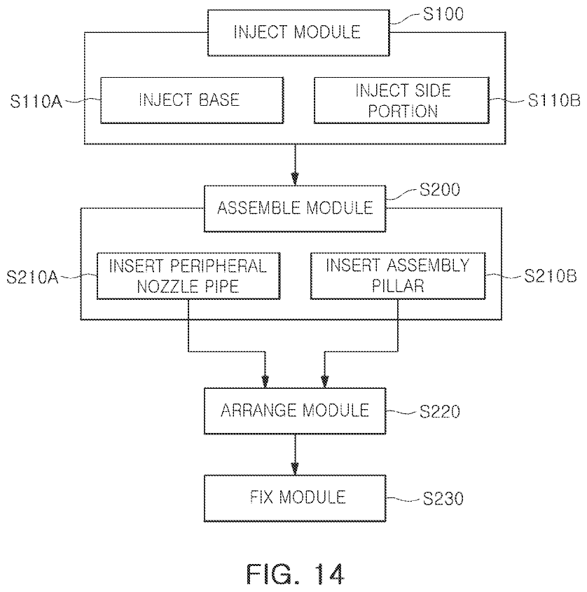

FIG. 14 is a flow chart illustrating a method for manufacturing a back nozzle according to an embodiment in the present disclosure.

Referring to FIG. 14 and based on FIGS. 10 through 13, the method for manufacturing the back nozzle 520 having the above-described structure will be described as follows.

The method for manufacturing the back nozzle 520 according to an embodiment in the present disclosure includes a module injection operation (S100) and a module assembly operation (S200).

First, the module injection operation (S100) is an operation of forming a plurality of modules by injecting a resin solution to form parts of the back nozzle 520 having the nozzle pipe N.

Next, the module assembly operation (S200) is an operation of assembling a plurality of modules to make the back nozzle 520. In this case, the nozzle pipe N formed in at least one of the plurality of modules is integrally formed with the module.

In this way, the back nozzle 520 of the present disclosure is manufactured so that it is integrally formed with the nozzle pipe N, thereby preventing the nozzle pipe N from rising when the high-temperature chemical liquid is discharged.

Specifically, first, the module injection operation (S100) will be described in detail.

The module injection operation (S100) includes a base injection operation (S110A) and a side portion injection operation (S110B).

The plurality of modules includes one base module 521 and the plurality of side modules 522, and the nozzle pipe N includes the central nozzle pipe N1 formed in the base module 521 and the peripheral nozzle pipe N2 formed in the side module 522.

Here, the base injection operation (S110A) is an operation of manufacturing the base module 521 in which the plurality of pipe holes 521a are formed. In this base injection operation (S110A), the central portion of the base module 521 is formed with the central nozzle pipe N1.

In addition, the side portion injection operation (S110B) is an operation of manufacturing the plurality of side modules 522. In the side portion injection operation (S110B), some of the plurality of side modules 522 are formed with the peripheral nozzle pipe N2 corresponding to the pipe hole 521a.

In this way, in the base injection operation (S110A), the base module 521 is manufactured. In this case, the base module 521 is injection molded so that the central nozzle pipe N1 is formed integrally with the base module 521. In addition, in the side portion injection operation (S110B), the side module 522 is manufactured. In this case, the side module 522 is injection molded so that the peripheral nozzle pipe N2 is formed integrally with the side module 522.

The base injection operation (S110A) and the side portion injection operation (S110B) may be performed independently regardless of the order.

In the base injection operation (S110A), the base module 521 may have the plurality of base holes 521b formed along the side portion of the base module 521, and in the side portion injection operation (S110B), the side module 522 may be formed with the side hole 522a corresponding to the base hole 521b.

In this way, in the module assembly operation (S200), the side module 522 may be fixed to the base module 521 by the fastening of the bolt member B.

Specifically, the module assembly operation (S200) includes a module arrangement operation (S220) and a module fixing operation (S230).

First, the module arrangement operation (S220) is an operation of arranging the plurality of side modules 522 in the base module 521 so that the base hole 521b and the side hole 522a communicate with each other.

Next, the module fixing operation (S230) is an operation of fixing the side module 522 to the base module 521 by fastening the bolt member B to the side hole 522a and the base hole 521b.

In this way, the plurality of side modules 522 may be firmly fixed along the side portion of the base module 521 by the module assembly operation.

The module assembly operation (S200) may further include a peripheral nozzle pipe insertion operation (S210A) as illustrated in FIGS. 10 and 12.

In the peripheral nozzle pipe insertion operation (S210A) which is an operation that is performed before the module arrangement operation (S220), an operation of inserting the peripheral nozzle pipe N2 of some of the plurality of side modules 522 into the pipe hole 521a of the base module 521 is performed. By the peripheral nozzle pipe insertion operation (S210A), some of the plurality of side modules 522 are arranged to extend in the longitudinal direction without the peripheral nozzle pipe N2 interfering with the base module 521, and may be connected to the chemical liquid supply line 511 or the gas supply line 512 formed in the lower supply unit 510. In addition, as the peripheral nozzle pipe N2 is inserted into and arranged in the pipe hole 521a, some of the plurality of side modules 522 may be firmly assembled to the base module 521.

Furthermore, in the side portion injection operation (S110B), the remainder of the plurality of side modules 522 may be formed with the assembly pillar P corresponding to the pipe hole 521a.

In this case, the module assembly operation (S200) may further include an assembly pillar insertion operation (S210B) as illustrated in FIG. 11.

In the assembly pillar insertion operation (S210B) is an operation that is performed before the module arrangement operation (S220), and is an operation of inserting the assembly pillar P of the remainder of the plurality of side modules 522 into the pipe hole 521a of the base module 521. By the assembly pillar insertion operation (S210B), the remainder of the plurality of side modules 522 may be firmly assembled to the base module 521.

Meanwhile, in the side portion injection operation (S110B), the peripheral nozzle pipe N2 may be formed in a structure where an upper end portion N2a thereof is closed. That is, when manufacturing the side module 522 in the side portion injection operation (S110B), the upper end portion N2a of the peripheral nozzle pipe N2 formed integrally with the side module 522 is not open, in other words, has a closed structure.

In this case, the method of manufacturing the back nozzle 520 according to the present disclosure may further include a pipe end cutting operation.

The pipe end cutting operation is an operation performed after the module assembly operation (S200), and an operation of cutting the closed upper end portion N2a of the peripheral nozzle pipe N2 to form a pipe outlet is performed.

In this pipe end cutting operation, the closed upper end portion N2a of the peripheral nozzle pipe N2 is cut horizontally or obliquely, so the direction of the pipe outlet may be selected.

As a result, according to the present disclosure, the nozzle pipe N is formed integrally with the back nozzle 520 to prevent the nozzle pipe from protruding as the nozzle pipe N rises upward when the high-temperature chemical liquid is discharged, thereby appropriately spraying the chemical liquid or gas onto the bottom side of the substrate.

According to an exemplary embodiment in the present disclosure, as set forth above, a nozzle pipe is integrally formed with a back nozzle to prevent the nozzle pipe from protruding as the nozzle pipe rises upward when a high-temperature chemical liquid is discharged, thereby appropriately spraying the chemical liquid or gas onto a bottom side of a substrate.

Although exemplary embodiments of the present disclosure has been described with reference to the accompanying drawings, those skilled in the art will appreciate that various modifications and alterations may be made without departing from the spirit or essential feature of the present disclosure. Therefore, it should be understood that the above-mentioned embodiments are exemplary in all aspects but are not limited thereto.

What is claimed is:

1. A back nozzle, comprising:
a base module formed with a central nozzle pipe; and
a plurality of side modules installed along a side portion of the base module, some of which have peripheral nozzle pipes formed thereon.

2. The back nozzle of claim 1, wherein the central nozzle pipe is integrally formed with the base module, and the peripheral nozzle pipe is integrally formed with the side module.

3. The back nozzle of claim 2, wherein the base module has a plurality of pipe holes formed around the central nozzle pipe, and
the peripheral nozzle pipe is inserted into the pipe holes and assembled.

4. The back nozzle of claim 3, wherein the remainder of the plurality of side modules are formed with assembly pillars, and
the assembly pillars are inserted into the pipe holes and assembled.

5. The back nozzle of claim 2, wherein the base module has a plurality of base holes formed along the side portion thereof,
the side module is formed with a side hole corresponding to the base hole, and
the side module is fixed to the base module by fastening a bolt member to the side hole and the base hole.

6. A substrate treating apparatus, comprising:
a plurality of process chambers respectively performing a process on a substrate;
a support unit disposed within the process chamber and supporting the substrate; and
a back nozzle unit disposed to penetrate through the support unit,
wherein the back nozzle unit includes a supply unit with a built-in chemical liquid supply line or gas supply line; and a back nozzle connected to the chemical liquid supply line or the gas supply line, installed at an upper end of the supply unit, and spraying a chemical liquid or gas toward a bottom side of the substrate, and
the back nozzle includes a base module formed with a central nozzle pipe; and a plurality of side modules installed along the side portion of the base module, some of which have peripheral nozzle pipes formed thereon.

7. The substrate treating apparatus of claim 6, wherein the central nozzle pipe is integrally formed with the base module, and
the peripheral nozzle pipe is integrally formed with the side module.

8. The substrate treating apparatus of claim 7, wherein the base module has a pipe hole formed around the central nozzle pipe, and
the peripheral nozzle pipe is inserted into the pipe hole and assembled.

9. The substrate treating apparatus of claim 8, wherein the remainder of the plurality of side modules is formed with an assembly pillar, and
the assembly pillar is inserted into the pipe hole and assembled.

10. The substrate treating apparatus of claim 7, wherein the base module has a plurality of base holes formed along the side portion thereof,
the side module is formed with a side hole corresponding to the base hole, and
the side module is fixed to the base module by fastening a bolt member to the side hole and the base hole.

11. A method for manufacturing a back nozzle, comprising:
a module injection operation of forming a plurality of modules by injecting a resin liquid to form parts of a back nozzle having a nozzle pipe; and
a module assembly operation of assembling the plurality of modules to make the back nozzle,
wherein the nozzle pipe formed in at least one of the plurality of modules is integrally formed with the module.

12. The method of claim 11, wherein the plurality of modules includes one base module and a plurality of side modules, the nozzle pipe includes a peripheral nozzle pipe formed on the side module, and
the module injection operation includes: a base injection operation of manufacturing the base module in which a plurality of pipe holes are formed; and
a side portion injection operation of manufacturing the plurality of side modules, and
in the side portion injection operation, some of the plurality of side modules are formed with the peripheral nozzle pipe corresponding to the pipe holes.

13. The method of claim 12, wherein the nozzle pipe further includes a central nozzle pipe formed in the base module, and
in the base injection operation, a central portion of the base module is formed with the central nozzle pipe.

14. The method of claim 12, wherein in the base injection operation, a plurality of base holes are formed along the side portion of the base module, and
in the side portion injection operation, the side module is formed with a side hole corresponding to the base hole.

15. The method of claim 14, wherein the module assembly operation includes:
a module arrangement operation of arranging the plurality of side modules in the base module so that the base hole and the side hole communicate with each other; and
a module fixing operation of fixing the side module to the base module by fastening a bolt member to the side hole and the base hole.

16. The method of claim 15, wherein the module assembly operation further includes a peripheral nozzle pipe insertion operation of inserting the peripheral nozzle pipes of some of the plurality of side modules into the pipe holes of the base module, before the module arrangement operation.

17. The method of claim 15, wherein in the side portion injection operation, the remainder of the plurality of side modules are formed with assembly pillars corresponding to the pipe holes.

18. The method of claim 17, wherein the module assembly operation further includes an assembly pillar insertion operation of inserting the assembly pillars of the remainder of the plurality of side modules into the pipe holes of the base module, before the module arrangement operation.

19. The method of claim 12, wherein in the side portion injection operation, the peripheral nozzle pipe is formed in a structure where an upper end portion is closed, and
the method for manufacturing a back nozzle further includes a pipe end cutting operation of cutting the closed upper end portion of the peripheral nozzle pipe to form a pipe outlet, after the module assembly operation.

20. The method of claim 19, wherein in the pipe end cutting operation, the closed upper end portion of the peripheral nozzle pipe is cut horizontally or obliquely to select a direction of the pipe outlet.
